(19) United States
(12) Patent Application Publication
(10) Pub. No.: US 2011/0011351 A1
(43) Pub. Date: Jan. 20, 2011

(54) Pet Chew Toy

(76) Inventor: Jacquelyn Simoni, Glen Ellyn, IL (US)

Correspondence Address: Erickson Law Group, PC, 1749 S. NAPERVILLE ROAD, SUITE 202, WHEATON, IL, 60189, US

(21) Appl. No.: 12/835,301

(22) Filed: Jul. 13, 2010

Related U.S. Application Data
(60) Provisional application No. 61/225,128, filed on Jul. 13, 2009.

(51) Int. Cl. A01K 29/00

(52) U.S. Cl. 119/709

(57) ABSTRACT

A pet chew toy which provides dental cleaning benefits to pets is disclosed. The pet chew toy includes a fabric covering over a central body or core. Elevated portions extend from the fabric surface and may be arranged in rows, rings, patterns, or any other decorative design. Elevated portions may be arranged to accommodate the dental structure of various types of pets. Bristles are secured to the elevated portions, and extend in a direction generally horizontal to the surface of the fabric. Bristles may be of various lengths to accommodate different sized teeth. In use, when a pet chews on the toy, the pet's teeth comes in contact with the bristles to allow the bristle to generate a brushing motion. The chew toy may include an internal compartment for holding and dispensing pet treats, and/or may include a noise making element within the chew toy to capture the pets attention.

This invention claims the benefit of U.S. Provisional Application No. 61/225,128 filed on Jul. 13, 2009.

### FIELD OF THE INVENTION

This invention relates in general to pet toys, such as pet chew toys.

### BACKGROUND OF THE INVENTION

Chew toys are often given to pets to alleviate boredom, prevent destructive chewing behavior by pets, or in general to provide an outlet for the natural chewing habits of pets. Chew toys which provide dental benefits to animals have been known to be given to pets to provide an outlet for their natural chewing urge, while simultaneously providing dental benefits.

The maintenance of good dental hygiene is often more challenging for animals since daily brushing is typically not feasible due to the difficulty in brushing s pet's teeth. As a result, animals such as cats and dogs may develop dental disease if their teeth are not cleaned properly. Serious health problems, such as gum disease and infections, may occur when a pet's dental hygiene is not maintained. To further the severity of the problem, pets are not able to articulate their discomfort to their owners. As such, discomfort may go unnoticed for prolonged periods of time during which the pet suffers in silence. By the time symptoms of dental disease manifests itself to be noticeable by the owner, or has effected a behavioral change noticeable to the owner, both the suffering of the pet and the progression of dental disease has progressed unnecessarily. Thus it is beneficial to provide preventative dental care to a pet.

Chew toys or items which can be used to clean a pet's teeth when the pet chews may be made of rubber such as the KONG® Ball, rawhide, rope, or may be in the form of edible dog treats such as GREENIES® or MILK BONE®.

The KONG® is a rubber chew toy having ridges and grooves which come into contact with the pet's teeth as the pet chews. However, the ridges and grooves are not able to reach in and clean between small interdental spaces. Treats which can assist in cleaning the pet's teeth as the pet chews on the treat tend to soften as parts of the treat come into contact with saliva. This reduces the abrasive characteristic of the treat, and does not allow the treat to perform effectively to clean a pet's teeth. Rawhide chewing devices may be more resistant to softening due to saliva, but are typically not formed such that small spaces between a pet's teeth can be reached for cleaning. Rawhide chew toys also may lead to intestinal obstruction if swallowed. Rope chew toys are also unable to reach small spaces between a pet's teeth.

The present inventor has recognized a need for a pet chew toy which can promote effective teeth cleaning.

The present inventor has recognized the need for a chew toy which can cater to various types of teeth in a pets oral cavity.

### SUMMARY OF THE INVENTION

In one embodiment, the pet chew toy comprises a soft body, elevating portions extending from the soft body to which bristles are secured, and a cover disposed over the body. The chew toy can be of any shape and size suitable for a pet. The bristles are aligned generally parallel to the surface of the chew toy, on at least one side of the elevating portion. Alternatively, the bristles may appear on both sides of the elevating portion. The bristles may be arranged in rows, circular patterns, or any other pattern or shape.

In another embodiment, the pet chew toy further comprises a tube for containing pet treats or pet food which are gradually dispensed when a pet moves the pet chew toy in a manner to allow a dispensing mechanism to dispense the pet treat.

Numerous other advantages and features of the present invention will be become readily apparent from the following detailed description of the invention and the embodiments thereof, from the claims and from the accompanying drawings.

### BRIEF DESCRIPTION OF THE DRAWINGS

FIG. 1 is a side view of one exemplary embodiment of the pet chew toy.

FIG. 2 is a longitudinal cross sectional view of the chew toy taken along line 2-2 in FIG. 1.

FIG. 2A is a longitudinal cross sectional view of an alternate embodiment of the pet chew toy.

FIG. 2B is a side view of one embodiment of the bristles for use with the chew toy.

FIG. 2C is a side view of an alternate embodiment of the bristles for use with the chew toy.

FIG. 2D illustrates a side of an alternate embodiment of the bristles where two rows of bristles are used.

FIG. 3 illustrates an alternate embodiment of the pet chew toy

FIG. 4 illustrates yet another embodiment of the pet chew toy.

FIG. 5 illustrates an exploded view of yet another alternate embodiment of the pet chew toy.

FIG. 6 is a cross sectional view of the food dispensing mechanism taken along line 6-6 of the chew toy in FIG. 5.

FIG. 7 illustrates an alternate embodiment of the pet chew toy.

### DETAILED DESCRIPTION OF THE PREFERRED EMBODIMENTS

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

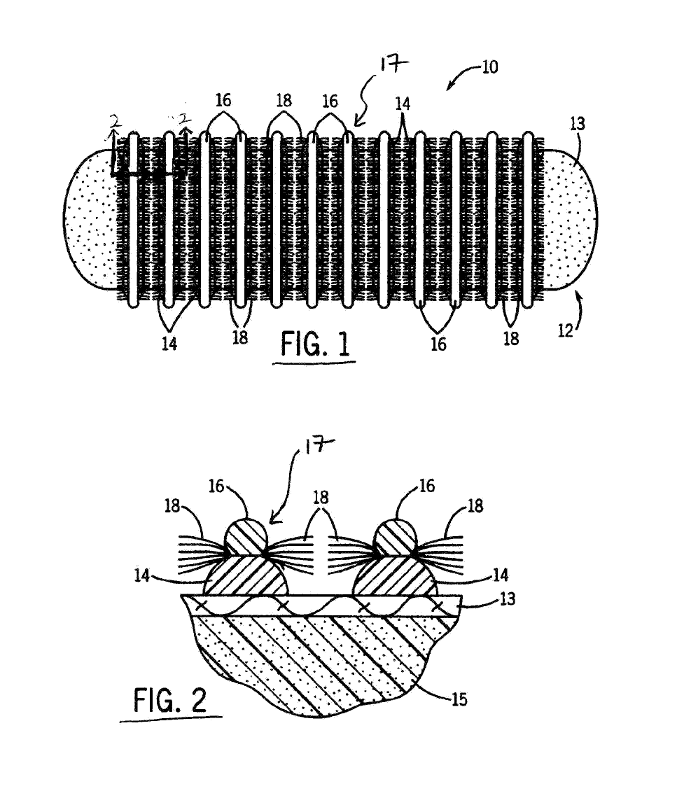

FIG. 1 illustrates one embodiment of the pet chew toy. The body 12 of the chew toy 10 is an elongate shape, such as a cylinder. The body 12 is preferably at least soft enough to allow a portion of a pets tooth to sink into the chew toy.

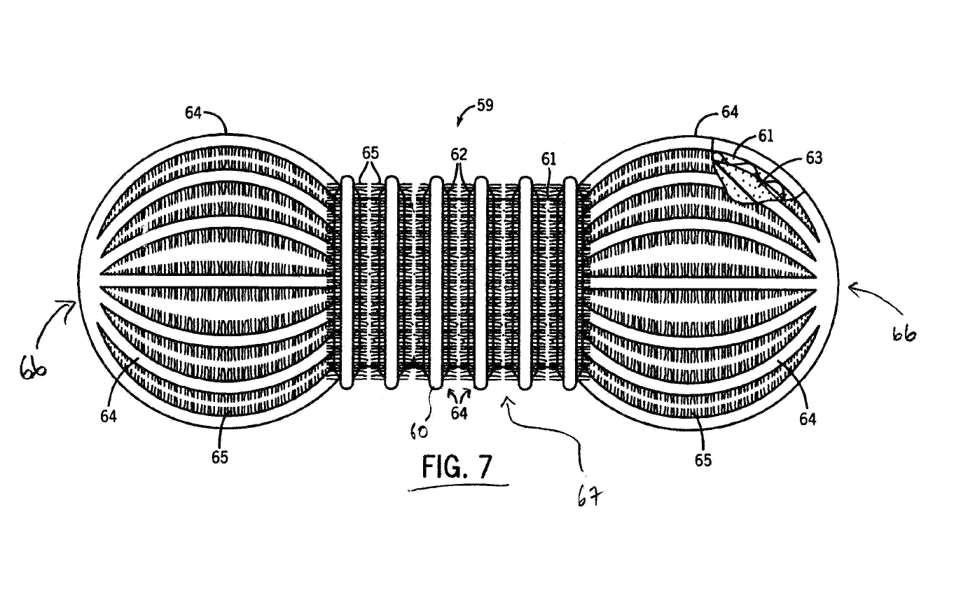

A plurality of elevated portions 17 are disposed around the circumference of the body 12 of the chew toy 10. Because the elevated portions 17 are disposed around the circumference of a cylindrical body 12, the elevated portions in FIG. 1 are in the shape of rings. The elevated portions 17 can be arranged along the body 12 of the chew toy in other arrangements, such as longitudinally along the chew toy, or in a helical shape. Combinations of arrangements, such as illustrated in FIG. 7, can also be used.

The body 12 of the chew toy can be any other suitable shape, such as in the shape of a bone, a spherical shape, a dumbbell shape, or a game ball shape such as a football or a basketball.

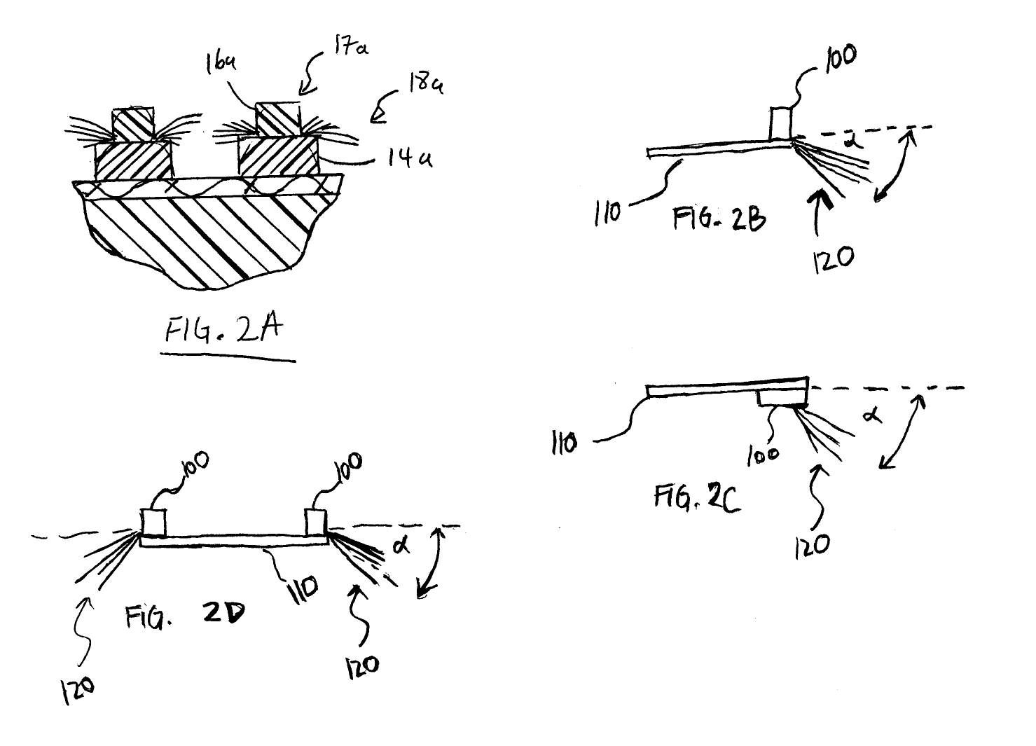

The elevated portion 17 extends from the surface 13 of the chew toy 10. The surface of the chew toy may be a cloth material. FIG. 2 illustrates in more detail the elevated portion 17, the surface layer 13, and the central core 15 of the body 12.

The elevated portion 17 comprises an upper elevated portion 16 disposed on a lower elevated portion 14. The upper elevated portion 16 is a rounded protrusion extending from the lower elevated portion. The upper elevated portion 16 is smaller than the lower elevated portion 14, but can also be the same size or bigger than the lower elevated portion 14. The upper elevated portion 16 and the lower elevated portion both have curved surfaces. Upper elevated portions 16 and lower elevated portions 14 of different shapes can also be used. For example, upper and elevated portions may have an angled surface such as a cube (FIG. 2A).

Bristles 18 are secured to the elevated portion 17 at the region where the upper elevated portion 16 and the lower elevated portion 14 meet. The bristles 18 extend generally horizontally from the elevated portion 17, and are generally parallel to the surface 13 of the chew toy, or are oriented such that the bristles begin to extend from the elevated portion horizontally. The bristles are preferably secured by sewing the bristles to the elevated portion 17. In another embodiment as illustrated in FIG. 2A, bristles 18a may be of different lengths to provide a different brushing dynamic. Bristles secured to the elevated portion 17a may be longer near the upper elevated portion 16a and shorter near the lower elevated portion 14a, or vice versa, to provide the desired brushing profile. For example, most teeth are thicker near the gum line. As such, shorter bristles may be desired for brushing portions of the tooth near the gum line.

In use, the chew toy is given to a pet, for example, a dog. As the dog chews on the chew toy, the dog's teeth make contact with the elevated portion 17. The upper elevated portion 16 can be tapered or curved, such as shown in FIG. 2, to facilitate the sliding of teeth over and down the upper elevated portion 16 to the lower elevated portion 14, during which time adjacent bristles are simultaneously in contact with both the inner and outer surface of a dog's tooth to effect dental cleaning.

The chew toy 10 may have a greater or lesser number of elevated portions than that illustrated in FIG. 1. In one embodiment, elevated portions and/or bristles may be intermittent throughout the surface of the chew toy. The size of the chew toy, the distance between adjacent elevated portions 17, and the length of the bristles can vary depending on the type or size of the animal for which the chew toy is used. The chew toy 10 may also comprise a squeak toy disposed within the chew toy 10 to amuse the pet and encourage the pet to continue to chew on the chew toy.

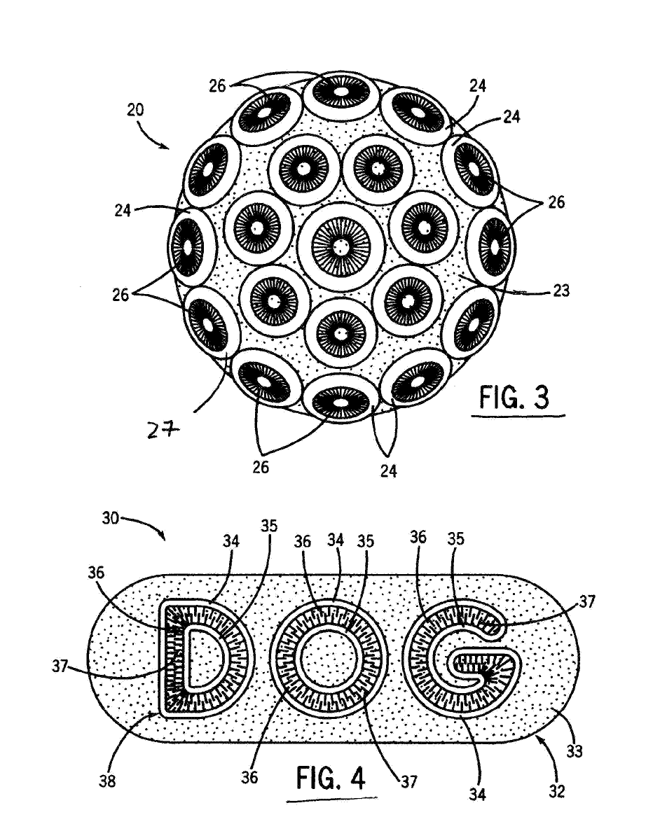

FIG. 3 illustrates an alternate embodiment of the chew toy. The chew toy 20 can be spherical for pets that prefer ball-shaped chew toys. The chew toy 20 comprises circular or ring shaped elevated portions 24 disposed throughout the surface 23 of the chew toy 20. Elevated portions 24 may have upper and lower elevated portions as described with respect to FIGS. 1 and 2. Bristles 26 are secured within the region defined by the elevated portions 24, and are oriented towards the center of ring. Bristles may also be secured on the outer side 27 of the elevated portion 24 such that the bristles point away from the center of the ring shaped elevated portion 24.

The elevated portions 24 may be any shape, and can be arranged in any pattern on the surface 23 of the chew toy, including in rows, curved lines, or stitching to mimic game balls such as a baseball or a basket ball. The surface 23 may be a cloth cover, or any other soft cover.

FIG. 4 illustrates yet another alternate embodiment of the chew toy 30 wherein the arrangement of the elevated portions can spell out words 38, letters, pictorial representations, or any other pattern on the chew toy. The chew toy in FIG. 4 has an elongated body 32 along which words, letters, and other depictions can be displayed.

The surface 33 of the elongated body 32 can be a cloth cover, or any other soft material. Words or patterns may be arranged on the elongated body 32 as shown, with the outline of each letter defined by elevated portions 34. Elevated portions are arranged such that bristles 36 secured to the outer elevating portion 34 and bristles 37 secured to the inner elevating portion 35 are oriented towards each other, thus allowing both sides of a tooth to be brushed simultaneously when a pets teeth is between the bristles.

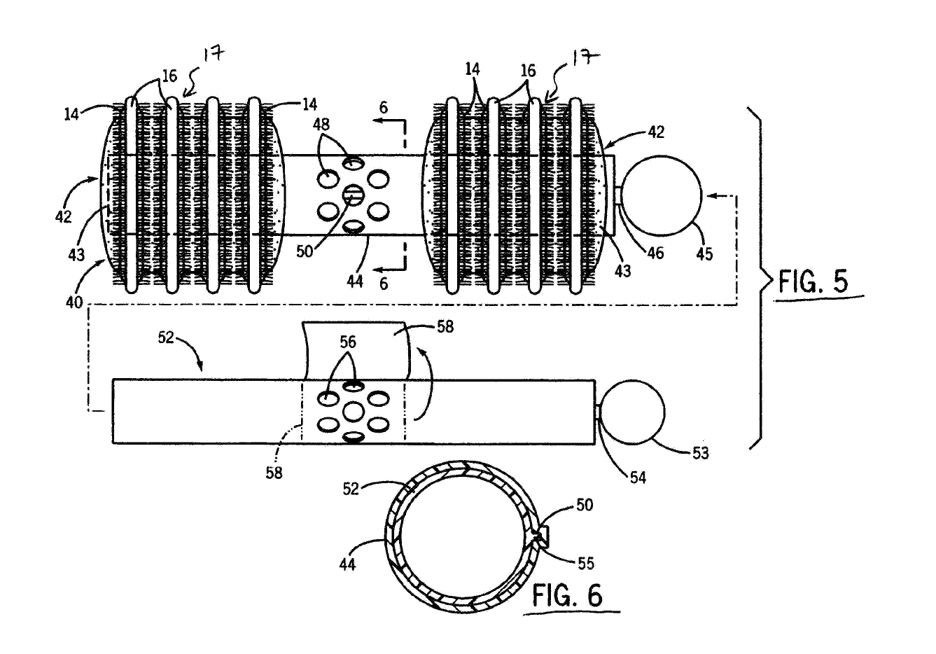

FIG. 5 illustrates an alternative embodiment of the chew toy. As illustrated, the chew toy 40 is dumbbell shaped with bristles located on the rounded distal ends. The chew toy 40 comprises a mechanism for dispensing pet treats. The chew toy 40 comprises soft portions 42 on either end, which give the chew toy its dumbbell shape. The soft portions 42 may have a foam interior, or contain stuffing, which is enclosed by a cloth or fabric material 43. Other soft materials may be used for covering the interior of the soft portions 42. Soft portions comprise elevated portions 17 comprising an upper elevated portion 16 and a lower elevated portion 14, on which bristles 18 are secured and from which the bristles extend.

The mechanism for dispensing pet treats comprises two coaxial tubes. An inner tube 52 contains food and is disposed coaxially within an outer tube 44. Inner tube 52 comprises inner tube holes 56 which, when aligned with outer tube holes 48, allow the treats in the inner tube 52 to exit the inner tube 52. The outer tube comprises a groove 50 which extends for at least a portion of the length of the outer tube 44. The inner tube 52 comprises a tongue 55 which extends for at least a portion of the length of the inner tube 52. When the inner tube 52 and the outer tube 44 are aligned such that the tongue 55 and groove 50 engage, the outer tube holes 48 and the inner tube holes 56 are aligned with each other to allow the pet to access the treat. Each of the inner tube 52 and outer tube 44 have flap closures 53, 45 respectively, which are connected to their respective tubes via living hinges 54, 46. Flap closures may be snapped into position to close the tube. Any other suitable mechanism for sealing the end of the tube to contain pet treats within may be used.

Inner tube 52 further comprises a closure flap 58 which can be used to cover the inner tube holes 56 when communication of the inner tube 52 to the outer tube 44 is not desired. In another embodiment, the inner and outer tubes are of suitable dimension to allow the inner tube to rotate freely within the outer tube without the use of a tongue and groove aligning mechanism. A pet is then challenged to move the chew toy until at least one inner tube hole and outer tube hole pair align so as to allow the pet access to the chew toy. The holes may be of any suitable size or shape to accommodate various types of pet treats.

FIG. 7 illustrates a dumbbell shaped chew toy 59 comprising more than one orientation of bristles 65 on the surface. The spherical ends 66 of the chew toy comprise longitudinally oriented elevated portions 64 and bristles 65 secured to the longitudinally arranged elevated portions. The surface 61 of the chew toy 59 can be a cloth covering which is disposed over a central core 63. The surface 61 material may be cloth cover, or any other material suitable for a chew toy such as a plastic or rubber material. The core 63 may be a foam material, plastic, rubber, or comprise a stuffing material such as cotton or other suitable material.

The central portion 67 of the dumbbell shaped chew toy 59 comprises elevated portions 64. Elevated portions 64 comprise upper elevated portion 60 and lower elevated portions 62, along the circumference of the cylindrical shaped central portion of the chew toy, in a similar manner as described with respect to FIG. 1. Bristles 65 extend from the elevated portions 64 laterally. By providing bristles in various orientations, the chew toy is able to accommodate a wide range of various chewing habits of pets.

In other embodiments, elevated portions can be at different elevations from the surface of the chew toy to take into consideration the various types of teeth a pet has, or to take into consideration the different dental patterns of various pet species. In an alternative embodiment, protrusions can be oriented in accordance with dental patterns of various types and/or sizes of pet teeth.

Bristles can be made from nylon, polypropylene, or polyester, or a combination thereof. Bristles can also be made from other suitable materials known to one skilled in the art. Bristles may be tab mounted brushes which can be arranged in a single row as illustrated in FIG. 2B or 2C, or may be arranged in a double row as illustrated in FIG. 2D. Bristles 120 can be welded or mounted, or otherwise attached on to tabs 100 which are connected to a backing 110. Alternatively, the bristles may be secured between the tab and the backing. The bristles 120 are attached to the chew toy by securing at least a portion of the backing region 110 to the surface of the chew toy. Bristles can be any cross sectional shape, any size in diameter, or any length depending on the type of pet the chew toy is designed for. In one embodiment, bristles may be made from 0.010″ polypropylene monofilament with 150 ends per inch (EPI) and a pile height of 0.490″. As illustrated in FIGS. 2B to 2D, the bristles which are to be attached to the chew toy may be pre-disposed at a downward angle “α” in anticipation of a slight upward fluctuation of the bristles when sewn or otherwise attached to the chew toy. Downward angle “α” may be between 0 to 45 degrees from the horizontal axis. The final orientation of the bristle may vary depending on the shape and compressibility of the chew toy, as well as the orientation of the bristles on the surface of the chew toy. Preferably the final orientation of the bristle is horizontal. A horizontal orientation may be achievable by adjusting and optimizing a combination of the following: the initial downward angle of the bristles, the downward force exerted on the backing 110 to secure the bristles onto the chew toy, the shape of the chew toy, and the orientation of the bristles on the surface of the chew toy.

The surface of the chew toy may be a fabric material made from suitable materials such as cotton, nylon, polyester and other synthetic materials, or a combination thereof. In other embodiments the surface of the chew toy may be a rubber or synthetic polymeric material covering. The surface of the chew toy can be either water absorbent or water resistant, and is preferably easy to clean. The surface of the chew toy may be made from an antibacterial material or be treated with an antibacterial layer.

The central core may be made from foam, rubber, plastic, or contain stuffing material made from synthetic materials. The central core may be continuous and generally solid, or may be hollow, or contain at least a hollow portion. A noise making mechanism, such as a squeaking mechanism, or a device which plays pre-recorded sound may also be disposed within the central core.

From the foregoing, it will be observed that numerous variations and modifications may be effected without departing from the spirit and scope of the invention. It is to be understood that no limitation with respect to the specific apparatus illustrated herein is intended or should be inferred.

All references, including publications, patent applications, and patents, cited herein are hereby incorporated by reference to the same extent as if each reference were individually and specifically indicated to be incorporated by reference and were set forth in its entirety herein.

The invention claimed is:

1. A pet chew toy which assists in cleaning a pets teeth, comprising:
a fabric covering over a central body;
elevated portions extending from the surface of the fabric covering;
bristles secured to the elevated portions.

2. The pet chew toy of claim 1, wherein the elevated portions further comprise an upper elevated portion and a lower elevated portion.

3. The pet chew toy of claim 1, wherein the bristles are secured to at least one side of the elevated portions.

4. The pet chew toy of claim 1, wherein the bristles extend such that they are generally parallel to the surface of the fabric covering.

5. The pet chew toy of claim 1, wherein the surface of the fabric covering comprise elevated portions in more than one orientation.

6. The pet chew toy of claim 5, wherein the elevated portions produce a pattern.

7. The pet chew toy of claim 1, further comprising a mechanism for dispensing treats.

8. The pet chew toy of claim 7, wherein the mechanism for dispensing treats comprises an inner tube for containing pet treats disposed coaxially within an outer tube, said inner tube and outer tube each having a closure at one end of the tube; said inner tube and outer tube each having a plurality of holes which when aligned allow for the pet treat to be dispensed.

9. The pet chew toy of claim 8, wherein the dispensing mechanism further comprises a tongue on at least a portion of the length of the inner tube, and a groove on at least a portion of the outer tube, wherein the engagement of the tongue and groove orients the inner and outer tubes such that the holes from each tube are aligned.

10. The pet chew toy of claim 7, wherein the diameter of the inner tube is smaller than the outer tube such that the inner tube rotates freely within the outer tube.

11. The pet chew toy of claim 7, wherein the inner tube further comprises a flap which is moveable between a first position which covers the holes in the inner tube, and a second position which does not cover the holes in the inner tube.

12. The pet chew toy of claim 1, wherein the elevated portions have different elevations.

13. The pet chew toy of claim 1, wherein the bristles are of different length.

14. The pet chew toy according to claim 1, wherein the central body is composed of a resiliently compressible material.
